(19) United States
(12) Patent Application Publication
(10) Pub. No.: US 2008/0257173 A1
(43) Pub. Date: Oct. 23, 2008

(54) DESSERT AND ICE CREAM MAKING APPARATUS

(76) Inventor: Robert Radi, Beverly Hills, CA (US)

Correspondence Address: EDWIN TARVER, 16830 Ventura Blvd., SUITE 360, Encino, CA, 91436, US

(21) Appl. No.: 11/736,927

(22) Filed: Apr. 18, 2007

(51) Int. Cl. A23C 3/04

(52) U.S. Cl. 99/455

(57) ABSTRACT

A dessert and ice cream making apparatus for use within or outside refrigerators or freezers, comprising a receptacle, a stirrer with at least one horizontal and one vertical blade to stir the contents of the receptacle, an electric motor for driving the stirrer, a housing for enclosing the electric motor, a locking means to engage and lock the housing on top of the receptacle, a means to shut off the electric motor after the receptacle contents reach a required density and a control panel. The stirrer is designed to scrap the inner surfaces of the receptacle. The apparatus also comprises a container with a securing member to receive and secure the receptacle, to form ice surrounding the receptacle. The container with ice can act as an ice box for the receptacle to allow the apparatus function outside the refrigerator.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to dessert and ice cream makers, and more particularly to an electrically operated dessert and ice cream making apparatus that has an improved stirrer and can be used within or outside refrigerators or freezers.

Several battery operated ice cream makers have been developed in art. U.S. Pat. No. 6,510,704 to Russel discloses a battery-operated ice cream maker to be used in the freezer compartment of any domestic or commercial refrigerator and/or ice chest comprising, product containers into which the ice cream ingredients are placed, a timer-controlled creamer for stirring the ingredients, a motorized lid connected to said creamer, a temperature sensor making contact with said product container, a container housing where said product containers and cooling mechanisms are located, an audible means to indicate completion of process, and a storage lid to cover the product container.

U.S. Pat. No. 4,716,822 to O'Brien discloses a domestic ice-cream maker for insertion in a freezer consisting of a container in the form of an annular trough, a mixing blade being arranged in the trough for rotating around the axis of the trough and being driven by an electric motor which is characterized by the provision of a fan or fans arranged above the container to direct a stream of air downwardly onto the surface of ice-cream mix in the container to produce rapid freezing of the ice-cream mix when the ice-cream maker is inserted in the freezer compartment of a refrigerator. Preferably, the electric motors are driven by a pack of rechargeable battery cells contained in the ice-cream maker.

In U.S. Pat. No. 3,985,347 Doyel an ice cream machine is disclosed which includes a dasher positioned in a receptacle to stir the ingredients. A fixed, non-rotatable post is also positioned in the receptacle in cooperating relationship within the dasher. The dasher is spaced from the wall and bottom of the receptacle and is of a novel configuration. The dasher is rotated at a low speed by a power unit contained entirely within the machine. Ice cream is made using the machine within the freezer compartment of a refrigerator.

Although above mentioned apparatuses serve the same purpose as the instant invention, the stirrer design and the means to automatically stop the stirrer depending on the density of the contents of the device are different. In addition, the present invention can also function outside the refrigerator.

### SUMMARY

The present invention is an assembly for making cool or frozen desserts, including ice cream. The assembly comprises a receptacle with a protrusion inside at its center to increase its inner surface area and serve as a hub that maintains the position of a stirrer. The stirrer comprises a paddle with one horizontal blade and one vertical blade to stir the contents of the receptacle. The stirrer is attached to a battery operated electric motor for rotating the stirrer, which is enclosed in a housing.

The electric motor and the batteries are associated with a means for deactivating the motor when a specific level of resistance against the stirrer is reached. The deactivation means is associated with a selection means that allows a user to select various resistance levels at which the motor will be deactivated.

The assembly also comprises a container with a securing member to receive and secure the receptacle inside the container. Salty water is introduced into a ring-shaped space between the container and receptacle to form an ice ring around the receptacle. When the ice ring is used, the assembly can be used outside a freezer.

The electric motor, batteries and associated controls are enclosed in the housing and the stirrer is connected to the shaft of the motor. The housing connects to the receptacle to secure it in place and prevent material from escaping the receptacle while the assembly is in use.

To use the assembly, a dessert mixture is poured into the receptacle. The housing, with the stirrer attached, is aligned and locked over the top of the receptacle so that the stirrer is immersed in the dessert material. A locking means, in one preferred embodiment a latch system, is engaged to secure the assembly. After a user selects the desired level of resistance; the level at which the motor will deactivate, the assembly is placed inside a refrigeration unit, such as the freezer of a domestic refrigerator and is switched on to commence operation. When the material in the receptacle achieves a pre-specified density, the resistance causes the stopping means associated with the motor to stop the stirrer. The apparatus is then removed from the freezer, the housing unlocked, and the material dispensed. In an alternate embodiment, the container with the ice ring can be used in addition to or instead of operating the device in a freezer.

### BRIEF DESCRIPTION OF THE FIGURES

FIG. 1 is front view of the dessert and ice cream making apparatus in accordance with the present invention.

FIG. 2 is a perspective view of the receptacle.

FIG. 3 is a perspective view of the stirrer.

FIG. 4 is an unassembled view of housing with the electric motor and batteries.

FIG. 5 is an assembled view of housing with the electric motor and batteries inside and the stirrer attached.

FIG. 6 is an alternate embodiment of the control means on the housing.

FIG. 7 is a perspective view of the container.

FIG. 8 is a perspective view of the container with the receptacle secured in it using the ring member.

FIG. 9 is a top view of the container with the receptacle secured in it using the ring member.

### FIGURES—REFERENCE NUMERALS

10 . . . Dessert and Ice Cream Making Apparatus
12 . . . Receptacle
14 . . . Protrusion
16 . . . Stirrer
18 . . . . Electric Motor
20 . . . Housing
22 . . . Battery
24 . . . Latch System
26 . . . Knob
28 . . . Splash Guard
30 . . . Spindle
32 . . . Motor Shaft
34 . . . Blade
36 . . . Indentation
38 . . . Top Cover Portion of Housing
40 . . . Lip
42 . . . Recharge Light
44 . . . On/off Switch
46 . . . Reset Button
48 . . . Container
50 . . . Ring Member
52 . . . Marking
54 . . . Stirrer Frame
56 . . . Button
58 . . . Indicator Light

### DETAILED DESCRIPTION

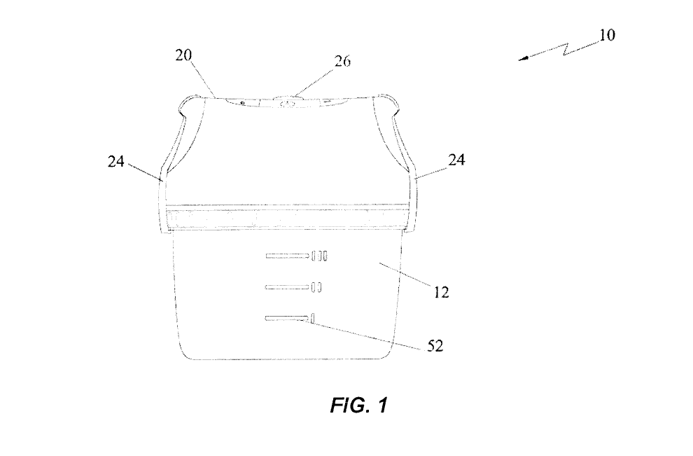

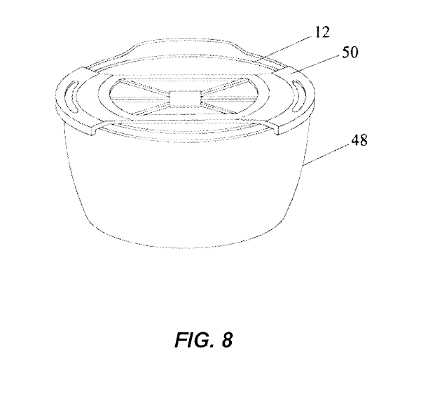

Referring to the drawings, a preferred embodiment of the dessert and ice cream making apparatus is illustrated and generally indicated as 10 in FIGS. 1 through 8. The apparatus 10 can be used within or outside refrigerators or freezers.

Referring to FIGS. 1 through 7, the apparatus comprises a receptacle 12 for placing, stirring and freezing the dessert mixture, a stirrer 16, a battery operated electric motor 18, a housing 20 for enclosing an electric motor 18 and batteries 22, a latch system 24, and a control means.

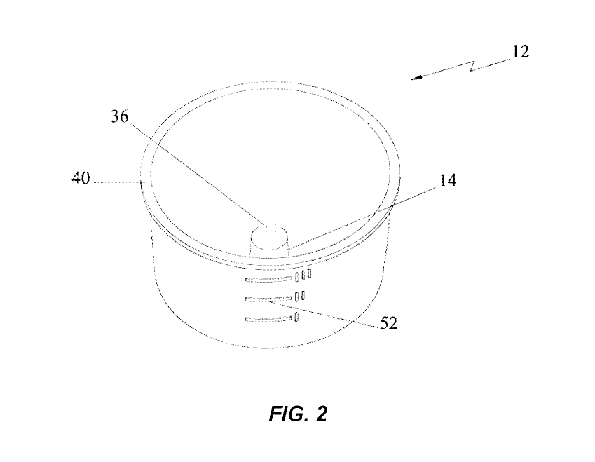

Referring to FIGS. 1 and 2, the receptacle 12 is made of heat conducting materials such as steel, aluminum or copper. The receptacle 12 is provided with a protrusion 14 inside it located at its centre protruding from the bottom surface, to increase the surface area of the receptacle. The inside surface of the receptacle 12 is coated with nickel or anodized to increase the smoothness and the heat conductivity. The outer surface of the receptacle has markings 52 to select the level of dessert mixture. The receptacle 12 also has a lip 40 for locking the housing to it using the latch system 24.

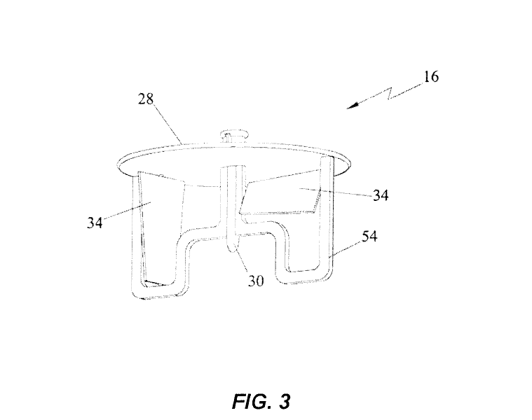

Referring to FIG. 3, the stirrer 16 has a splash guard 28, a spindle 30, a frame 54 surrounding the spindle and a horizontal and a vertical blade 34 on either sides of the spindle 30, disposed between the spindle and the frame. The splash guard 28 is a disc-like member on top of the frame 54. The spindle 30 is attached to the shaft of the electric motor 32. The frame 54 is dimensioned to scrap the inner surfaces of the receptacle as the stirrer rotates. When the stirrer 16 rotates, the blades agitates the ingredients from top to bottom and from left to right, thereby allowing a vortex flow of the mix while stirring and thus produces a better mix. In another embodiment, the stirrer 16 can have plurality of horizontal and plurality of vertical blades. The spindle 30 rests on the protrusion 14 while rotating. The protrusion 14 has an indentation 36 to accommodate the spindle on it 30, while the stirrer 16 is rotating.

The stirrer 16 is driven by a battery operated electric motor 18 which is capable of driving the stirrer 16 at different torque and rpm ratios. The motor 18 rotates the stirrer to mix the contents in the receptacle 12, while the whole apparatus 10 rests in the ice box compartment. The batteries 22 for running the motor 18 can comprise any given number or combination of rechargeable or interchangeable batteries.

Alternatively, the electric motor 18 can be powered by a plug in power source inside the refrigerator. The electric motor can also be replaced by a manual wind up spring loaded mechanism to drive the stirrer.

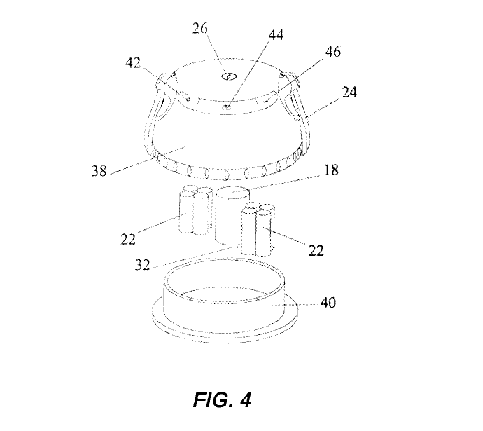

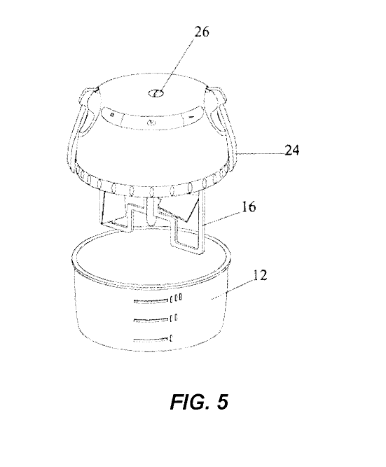

Referring to FIGS. 4 and 5, the housing 20 encloses the electric motor 18 and the batteries 22. The housing 20 comprises a top cover portion 38 and a bottom insulating portion (not shown). The insulating portion comprises a hollow cylinder closed at one end and fits in the top portion 38. The batteries 22 and the electric motor 18 are enclosed between the top cover portion 38 and the insulating portion. The insulating portion protects the electric motor 18 and the batteries 22 from exposure to receptacle contents. The insulating portion includes a hole at its centre to allow the motor shaft 32 to get connected with the stirrer 16. The housing can be made of polymer or metal.

The control means is provided on the top cover portion 38. The control means comprises a knob 26, an LED recharge light 42, an on/off switch 44, and a reset button 46. As the apparatus 10 works the density of the dessert mixture increases and it offers resistance to the movement of the stirrer 16. A knob 26 is provided to select a level of resistance to the stirrer 16 that causes the motor 18 to turn off when the selected resistance is reached.

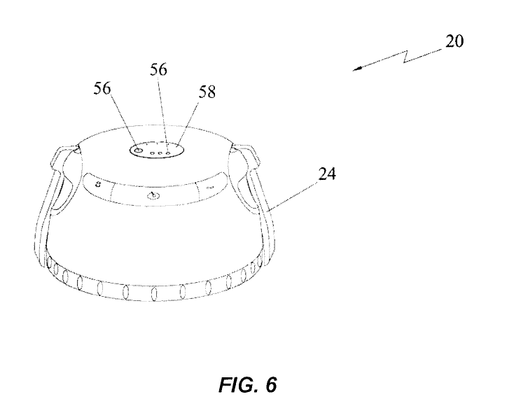

The knob 26 is located at the centre of the top cover portion 38 of the housing. The knob 26 allows a user to select a level of resistance that causes the stirrer to automatically stop the stirrer 16 when a pre-specified density of the dessert mix is achieved. This allows the apparatus 10 to work by itself and eliminates the need to attend the device till the dessert is made. In an alternate embodiment as shown in FIG. 6, the housing comprises buttons 56 in place of the knob 26 to select a level of resistance to the stirrer 16, indicator lights 58, and an on/off button.

The latch system 24 is used to lock the housing 20 to the receptacle 12. Alternatively, standard clips, snaps or fasteners can also be used to secure the housing 20 and the receptacle 12.

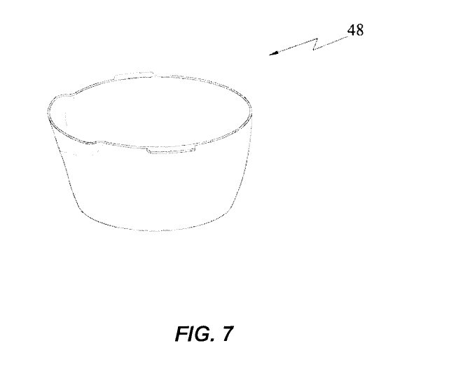

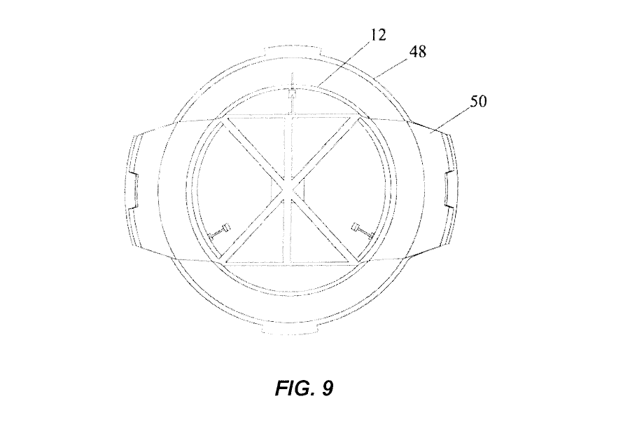

Referring to FIGS. 7 through 9, the apparatus 10 also comprises a container 48 to make ice and use it as a ice box to freeze the contents of the receptacle 12 while stirring. The container 48 is larger than the receptacle 12 to receive the receptacle, leaving a gap between the receptacle and its walls. A mixture of salt and water is poured and the receptacle is secured to the container by a ring member 50, thereby preventing it from floating on the water. The gap is now filled with salty water. The container 48 along with receptacle 12 and water is placed in a freezer, to make ice surrounding the receptacle. This container 48 with ice can now act as an ice box for the receptacle 12 to allow the apparatus function outside the refrigerator. The container 48 also includes a pouring lip.

The dessert ingredients are poured in the receptacle 12 up to a recommended level. The housing 20 with the stirrer 16 is aligned and secured to the receptacle 12. The knob 26 is rotated depending on the required density of the dessert. The apparatus 10 without the container is then placed inside a freezer or a refrigerator and is switched on. The stirrer stops rotating after the dessert mixture reaches the required density.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A device for making desserts including ice cream, comprising:
(a) a receptacle for holding a dessert mixture;
(b) a stirrer adapted to abut and slide along the inner sides of the receptacle;
(c) a driving means for driving the stirrer;
(d) a housing for enclosing the means for driving the stirrer;
(e) a locking means to engage and lock the housing on top of the receptacle; and
(f) a means for shutting off the driving means when a specified level of resistance is reached;

2. The device of claim one, wherein multiple specified levels of resistance are selectable by a control means.

3. The device of claim one, wherein the stirrer creates a vortex flow in the contents of the receptacle.

4. The device of claim one, wherein the receptacle includes a means at the center of its bottom surface for engaging and centering the stirrer.

5. The device of claim 1, wherein the means for selecting a level of resistance comprises a knob located on the housing.

6. The device of claim one, wherein the device further comprises a container for receiving the receptacle, wherein a gap exists between the outer surface of the receptacle and the inner surface of the container.

7. The device of claim 6, wherein a securing means holds the receptacle inside the container to displace liquid in the container for forming an ice bath when the device is frozen prior to attaching the stirring means and driving means.

8. The device of claim 1, wherein the receptacle is made of conducting materials comprising stainless steel, aluminum or copper.

9. The device of claim 1, wherein the stirrer comprises a spindle and paddle with at least one horizontal blade one vertical blade.

10. The device of claim 9, wherein the stirrer comprises one horizontal paddle and one vertical paddle contained in an open frame, and the entire edge of the stirrer abuts the inner surface of the container.

11. The device of claim 10, wherein the blades are made of ceramic, metal, or a metal pouch filled with liquid gel that can be frozen.

12. The device claim 4, wherein a protrusion in the bottom center of the receptacle corresponds to a notch in the stirrer to hold the stirrer in position as it rotates.

13. The device of claim 12, wherein a protrusion in the stirrer corresponds to a notch in the bottom center of the receptacle to hold the stirrer in position as it rotates.

14. The device of claim 1, wherein the means for driving the stirrer comprises an electric motor capable of running at various pre-specified torques and RPM ratios.

15. The device of claim 14, wherein the electric motor is powered by a plug-in power supply.

16. The device of claim 14, wherein the electric motor is powered by rechargeable including interchangeable batteries.

17. The device of claim 1, wherein the means for driving the stirrer comprises a manually actuated mechanism.

18. The device of claim 1, wherein the housing comprises a top cover portion and a lower insulating portion to prevent temperature changes and exposure of the driving means to the contents of the receptacle.

19. The device of claim 1, wherein the housing is made of polymer or metal.

20. The device of claim 1, wherein the control panel is located on the housing.

21. The device of claim 1, wherein the control panel comprises a LED recharge light, an on/off switch and a reset button.

22. The apparatus of claim 1, wherein the locking means comprises fasteners including clips, snaps, interlocking tab, and twist-lock mechanisms.

23. The apparatus of claim 1, wherein the receptacle includes markings on its outer surface corresponding to measurements inside the receptacle.

24. The apparatus of claim 1, wherein the means for shutting off the driving means measures amps to gauge the level of resistance.

25. The apparatus of claim 1, wherein the means for selecting a level of resistance comprises buttons located on the housing.
